(19) United States
(12) Patent Application Publication
(10) Pub. No.: US 2022/0274468 A1
(43) Pub. Date: Sep. 1, 2022

(54) Auto safety window screen

(71) Applicant: Connie Jacqueline Audrey Kelloway, St. John's (CA)

(72) Inventor: Connie Jacqueline Audrey Kelloway, St. John's (CA)

(21) Appl. No.: 17/323,713

(22) Filed: May 18, 2021

Related U.S. Application Data
(60) Provisional application No. 63/028,720, filed on May 22, 2020.

(51) Int. Cl. B60J 1/20

(52) U.S. Cl. CPC B60J 1/2011

(57) ABSTRACT

A window screen for a vehicle includes: a slim metal frame, fitting securely sealed, the screen member being of predetermined shape to substantially fit a moulding of a window of the vehicle; and a mounting member to engage and secure the window from inside a door of the vehicle, wherein control of the frame is applied using control buttons to allow the frame to move up and/or move down, the control buttons being accessible on the door of the vehicle and/or a dash of the vehicle and/or a console of the vehicle.

### CROSS-REFERENCE

The present application claims priority from U.S. Provisional Patent Application No. 63/028,720, filed May 22, 2020, the entirety of which is incorporated by reference herein.

### SUMMARY

A claim safety window screen for all makes and models of automobile vehicles and commercial vehicles.

It is therefore, one of the principal objects of the invention to provide a simple, safe, and efficient screen for the use in automobile windows, and the like which will permit the window being raised and lowered without removing the screen, not to interfere with the operation of the sliding window at all.

Another object is to provide a durable screen window that will fit in place firmly and to provide a seal to prevent any opening along the edges of the device through which bees, bugs, insects or the like may prevent from entering the vehicle.

Another object is to provide such a screen mesh material which will reduce the harmful ultraviolet rays entering the vehicle.

Another object is to provide such a screen window which may be left in place in a vehicle window to allow air circulation to cool your vehicle, during the warmer months of the year.

Another object is to provide a durable screen window which place firmly sealed to provide durability from objects ie. Books, toys, baby bottles, shoes, hats, etc. from being tossed onto the road, and or incoming traffic to prevent accidents.

Another object is to provide a variety of multi colour screens, and or such material to custom colour match the vehicle.

Another object is to provide such a screen which has a flexible or resilient material, which may prevent small animals, cats and/or dogs from jumping out of the vehicle.

Another object is to provide such a device which uses inexpensive parts and materials in its manufacture, which is easy to assemble, effective, and affordable in its selling price.

Another more specific is to provide a device which is composed of 3 major parts or pieces. The frame member being of resilient material, bent and secured tightly sealed around the edges of the window frame, the mesh member being resilient material and having means whereby it may be readily shaped to the contour the window frame and the secured screen window frame secured whereas the screen frame may be secured on the inside door of the vehicle, using buttons to operate the screen window frame to allow the window screen to move up and to move down, and without interfering with the operation of a vehicle window.

A screen which is durable, and made of material to reduce the effect of ultraviolet rays entering a vehicle.

A screen of predetermined form to fit a frame member and to have a multi colours or colours custom to match the vehicle, for visible safety, so you are aware a screen is present, and exists.

According to one aspect, there is provided a window screen for a vehicle, having a slim metal frame, fitting securely sealed, the screen member of predetermined shape to substantially fit the said moulding of any such vehicle window. A mounting member to engage and secure the said window from inside the vehicle door. The controls of the frame member will be applied using buttons whereas the operation will allow the frame member to move up and or move down. The control buttons will be accessible on the vehicle door and or vehicle dash, or vehicle console depending on suitability of the vehicle.

According to another aspect, there is provided a window screen for a vehicle, a screen member shaped to substantially secure and seal the metal window frame. The material of the screen comprises a durable flexible material with some stretch so that it conforms back to natural shape. Also, the screen material blocks out and reduces ultraviolet light from entering the vehicle. The colour mesh screens are present to help prevent children from throwing items out the window, and to help prevent small animals, cats, and/or dogs from jumping out of a vehicle.

The window screen member can be shaped to suit any vehicle window. The window screen will not interfere or impede the visibility of seeing through the window of a vehicle. The window screen will not interfere with the raising and lowering of a window in any vehicle.

These and other objects and advantages of my invention will become more apparent as the description proceeds.

### BRIEF DESCRIPTION OF THE DRAWINGS

In the accompanying drawings forming part of this application:

FIG. 1 is a side view of a window screen installed at a window, with operational button function showing how the window screen goes up and goes down, to deter children from throwing items out the window, and to prevent small animals cat and/or dog from jumping out the window.

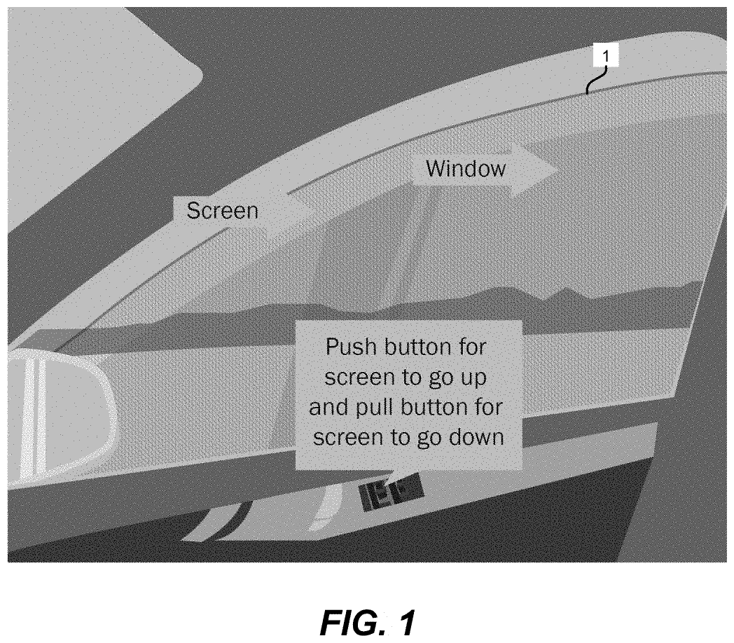

FIG. 2 is a side view of the window screen of predetermined form to fit a frame of any particular vehicle window, will be flexible, and durable; however, you will be able to see when the product is made, as it is hard to show the flexible as a drawing.

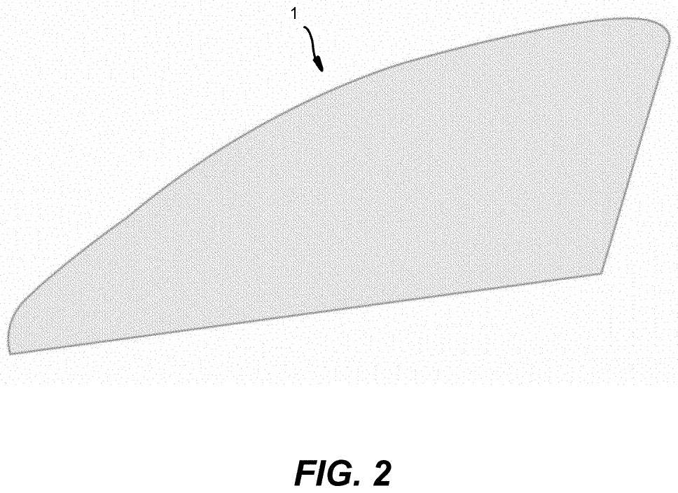

### DETAILED DESCRIPTION

In the drawings the reference, figure numerical 1 the reticulate or screen member of my device, which may be suitable mesh metal, or plastic screen material and it is cut to any desired predetermined shape to accommodate any given vehicle window and securely sealed around the vehicle window frame.

Also, the subject drawing indicated the operation of the vehicle window screen indicating buttons on the vehicle door to allow the screen to move up and or down motion. These buttons may be installed in the door panel or on the dash or console of a vehicle whichever is suitable.

The resilient frame member is made of metal material. The frame is of durable slim metal material and flexible mesh screen fits predetermined shape to accommodate any given vehicle window and is securely sealed.

The mesh screen material is made up of a material that reduces the amount of ultraviolet rays from entering the vehicle.

The mesh screen is durable and flexible material to prevent objects thrown from the vehicle window, and available in several colours, and custom colours to match the vehicle, colours to be present and exist, to help children from throwing items out the window and to help prevent small animals from jumping out of the window.

1. A window screen for a vehicle, comprising:
a slim metal frame, fitting securely sealed, the screen member being of predetermined shape to substantially fit a moulding of a window of the vehicle;
a mounting member to engage and secure the window from inside a door of the vehicle,
wherein control of the frame will be applied using control buttons to allow the frame to move up and/or move down, the control buttons being accessible on the door of the vehicle and/or a dash of the vehicle and/or a console of the vehicle.

2. A window screen for a vehicle, comprising:
a screen member shaped to substantially secure and seal a metal window frame of a window of the vehicle,
a material of the screen comprising a durable flexible material with some stretch so that it conforms back to natural shape, the screen material being configured to block out and reduce ultraviolet light from entering the vehicle,
the window screen being installable on the window of the vehicle to help prevent children from throwing items out of the window, and to help prevent small animals from jumping out of the vehicle.
